(19) United States
(12) Patent Application Publication
(10) Pub. No.: US 2010/0079886 A1
(43) Pub. Date: Apr. 1, 2010

(54) MAGNETIC TRANSFER MASTER CARRIER, MAGNETIC TRANSFER METHOD USING THE SAME, AND MAGNETIC RECORDING MEDIUM

(75) Inventors: Masakazu Nishikawa, Odawara-shi (JP); Naoto Fujiwara, Odawara-shi (JP); Yoichi Nishida, Odawara-shi (JP); Toshihide Ishioka, Odawara-shi (JP)

Correspondence Address: YOUNG & THOMPSON, 209 Madison Street, Suite 500, Alexandria, VA, 22314, US

(73) Assignee: FUJIFILM CORPORATION, Tokyo (JP)

(21) Appl. No.: 12/570,587

(22) Filed: Sep. 30, 2009

(30) Foreign Application Priority Data
Sep. 30, 2008 (JP) 2008-254687

(51) Int. Cl. G11B 5/86; G11B 5/82

(52) U.S. Cl. 360/16; 360/135; G9B/5.293; G9B/5.308

(57) ABSTRACT

A magnetic transfer master carrier to be placed on a perpendicular magnetic recording medium, including: a concavo-convex pattern corresponding to magnetic information to be transferred to the medium by application of a magnetic field, wherein a length (La) of a convex portion in the concavo-convex pattern and a length (Sa) of a space between the convex portion and another convex portion adjacent to the convex portion satisfy 1.3≦(Sa/La)≦1.9, and wherein a cycle length (La+Sa) is in the range of 50 nm to 145 nm, where the length (La) is the width of the convex portion with respect to a circumferential direction measured at a height equivalent to 50% of the height of the convex portion, and the length (Sa) is the width of the space with respect to the circumferential direction measured at the height equivalent to 50% of the height of the convex portion.

### BACKGROUND OF THE INVENTION

1. Field of the Invention

The present invention relates to a magnetic transfer master carrier for magnetically transferring information to a perpendicular magnetic recording medium, a magnetic transfer method using the magnetic transfer master carrier, and a magnetic recording medium.

2. Description of the Related Art

As magnetic recording media capable of recording information in a highly dense manner, perpendicular magnetic recording media are well known. An information recording area of a perpendicular magnetic recording medium is composed of narrow tracks. Thus, a tracking servo technique for accurate scanning with a magnetic head within a narrow track width and for reproducing a signal with a high S/N ratio is important for the perpendicular magnetic recording medium. To perform this tracking servo, it is necessary to record servo information, for example a servo signal for tracking, an address information signal, a reproduction clock signal, etc. as a so-called preformat at predetermined intervals on the perpendicular magnetic recording medium.

As a method for preformatting servo information on a perpendicular magnetic recording medium, there is, for example, a method wherein while a master carrier with a pattern including a magnetic layer, which corresponds to the servo information, is closely attached to the magnetic recording medium, a recording magnetic field (transfer magnetic field) is applied to the magnetic recording medium and the master carrier so as to magnetically transfer the pattern of the master carrier to the magnetic recording medium (refer to Japanese Patent Application Laid-Open (JP-A) Nos. 2003-203325 and 2000-195048 and U.S. Pat. No. 7,218,465B1, for example).

In this method, when the transfer magnetic field is applied to the magnetic recording medium and the master carrier with these closely attached to each other, a magnetic flux is absorbed into the magnetic layer on the pattern based upon the magnetized state of the master carrier, and the magnetic field is strengthened correspondingly to the concavo-convex shape of the pattern. By this magnetic field strengthened in the form of the pattern, only predetermined places on the magnetic recording medium are magnetized. Accordingly, magnetic materials with high saturation magnetization have hitherto been frequently used as materials for master magnetic layers (magnetic layers of master carriers).

Parenthetically, the magnetic layer of the master carrier is roughly several tens of nanometers in thickness and is therefore very thin. For that reason, once a transfer magnetic field is applied, a strong demagnetizing field is generated in the magnetic layer. When the demagnetizing field becomes strong, an effective magnetic field applied to the magnetic layer decreases even if a magnetic material with high saturation magnetization is used, and thus the concavo-convex magnetic layer comes into an unsaturated state. Hitherto, attempts have been made to bring the magnetic layer into a near-saturated state by further increasing an externally applied magnetic field to secure transfer magnetic field strength and increasing an effective magnetic field applied to the magnetic layer. However, since the magnetic layer magnetization increase rate related to the increasing of the applied magnetic field is in proportion to the strength of the applied magnetic field, the above-mentioned situation is, in effect, tantamount to a situation where a strong magnetic field is applied to a material with low saturation magnetization. The transfer magnetic field becomes strong on convex portions, causing the perpendicular magnetic recording medium to be magnetized in an almost saturated manner; however, the transfer magnetic field becomes strong on concave portions as well. Thus, the difference in transfer magnetic field strength between the convex portions and the concave portions is small. When servo information is transferred to the magnetic recording medium, with the difference in transfer magnetic field strength between the convex portions and the concave portions being small, a reversal of magnetization is caused at places (concave portions) that should not be magnetized, so that the quality of the recording signal degrades, which is a problem.

In order to reduce the occurrence of the problem, the master carrier's magnetic layer itself needs to be magnetized in a saturated manner at a desired transfer magnetic field strength at least when the transfer magnetic field is applied, thereby enabling the magnetization value to be large.

When the magnetization value of the master carrier's magnetic layer itself can be sufficiently increased by a transfer magnetic field having a minimum strength required to magnetize the magnetic recording medium, the difference in transfer magnetic field strength between the convex portions and the concave portions can be increased, which is particularly favorable.

Under such circumstances, it is thought that by changing the cross section of the pattern of the master magnetic layer and effectively magnetizing the surface of the magnetic layer in a saturated manner at an appropriate transfer magnetic field strength, the transfer magnetic field makes it possible to increase the magnetization value of the magnetic layer so as to perform high-quality magnetic transfer, and thus to realize a high-quality magnetized state of the magnetic recording medium.

Also, magnetic recording media are known to change in dynamic coercive force depending upon the frequency of an AC magnetic field applied. Although DC magnetic fields have also been used as transfer magnetic fields thus far, it has been thought that by using AC magnetic fields as magnetic fields applied in the initially magnetizing step and the magnetic transfer step and changing their frequencies, it is possible to change the magnetization behavior of the magnetic recording media so as to perform high-quality magnetic transfer, and thus to realize a high-quality magnetized state of the magnetic recording media.

The magnetic field difference between portions of the perpendicular magnetic recording medium, made correspondingly to the concavo-convex pattern of the master carrier, is determined depending upon the material of the master magnetic layer used for magnetic transfer. Therefore, it is necessary to design the dimensions of the master carrier and a magnetic transfer process in light of the material of the master magnetic layer and the magnetic properties of the magnetic recording medium.

As to designing of the dimensions of a master carrier, there has been a disclosure in which the ratio of the width of an edge of a convex portion to the width of a concave portion including slanting portions at both sides in a concavo-convex pattern (width of edge of convex portion/width of concave portion) is 0.4 or less (refer to JP-A 2008-41183, for example). However, this designing alone cannot stably secure sufficient signal quality.

Additionally, there have been disclosures in which magnetic transfer is performed using an AC magnetic field in designing of a magnetic transfer process (refer to Japanese Patent (JP-B) No. 4012334 and JP-A No. 10-40544). However, these disclosures are related to techniques for inplane magnetic recording media, not techniques for perpendicular magnetic recording media.

### BRIEF SUMMARY OF THE INVENTION

The present invention is aimed at solving the problems in related art and achieving the following object. An object of the present invention is to provide a magnetic transfer master carrier capable of performing stable, high-quality magnetic transfer and realizing a high-quality magnetized state of a magnetic recording medium; a magnetic transfer method using the magnetic transfer master carrier; and a magnetic recording medium.

Means for solving the problems are as follows.

<1> A magnetic transfer master carrier to be placed on a perpendicular magnetic recording medium, including: a concavo-convex pattern corresponding to magnetic information to be transferred to the perpendicular magnetic recording medium by application of a magnetic field, wherein a length (La) of a convex portion in the concavo-convex pattern and a length (Sa) of a space between the convex portion and another convex portion adjacent to the convex portion satisfy the relationship 1.3≦(Sa/La)≦1.9, and wherein a cycle length (La+Sa), which is the sum of the length (La) and the length (Sa), is in the range of 50 nm to 145 nm, where the length (La) is the width of the convex portion with respect to a circumferential direction measured at a height equivalent to 50% of the height of the convex portion, and the length (Sa) is the width of the space with respect to the circumferential direction measured at the height equivalent to 50% of the height of the convex portion.
<2> A magnetic transfer method including: initially magnetizing a perpendicular magnetic recording medium in a perpendicular direction; closely attaching the magnetic transfer master carrier according to <1> to the initially magnetized perpendicular magnetic recording medium; and magnetically transferring magnetic information to the perpendicular magnetic recording medium by applying a perpendicular magnetic field which acts in the opposite direction to the direction of a magnetic field applied in the initially magnetizing, with the perpendicular magnetic recording medium and the magnetic transfer master carrier closely attached to each other.
<3> The magnetic transfer method according to <2>, wherein a frequency (FI) of the magnetic field applied in the initially magnetizing and a frequency (FP) of the magnetic field applied in the magnetically transferring satisfy the relationship FI≦FP.
<4> The magnetic transfer method according to <3>, wherein the frequency (FP) of the magnetic field applied in the magnetically transferring is in the range of 5 Hz to 25 Hz.
<5> The magnetic transfer method according to one of <3> and <4>, wherein the frequency (FI) of the magnetic field applied in the initially magnetizing is in the range of 0.1 Hz to 5 Hz.
<6> A magnetic recording medium, onto which a servo signal has been recorded by the magnetic transfer method according to any one of <2> to <5>.

According to the present invention, it is possible to solve the problems in related art and achieve the object of providing: a magnetic transfer master carrier capable of performing stable, high-quality magnetic transfer and realizing a high-quality magnetized state of a magnetic recording medium; a magnetic transfer method using the magnetic transfer master carrier; and a magnetic recording medium.

### BRIEF DESCRIPTION OF THE DRAWINGS

FIG. 1A is an explanatory drawing showing a step in a perpendicular magnetic recording transfer method (Part 1).

FIG. 1B is an explanatory drawing showing a step in the perpendicular magnetic recording transfer method (Part 2).

FIG. 1C is an explanatory drawing showing a step in the perpendicular magnetic recording transfer method (Part 3).

FIG. 2A is a partially cross-sectional view showing a master disk according to an embodiment (Part 1).

FIG. 2B is a partially cross-sectional view showing a master disk according to another embodiment (Part 2).

FIG. 3A is an explanatory drawing showing a method for producing a master disk, according to an embodiment (Part 1).

FIG. 3B is an explanatory drawing showing the method for producing a master disk, according to the embodiment (Part 2).

FIG. 3C is an explanatory drawing showing the method for producing a master disk, according to the embodiment (Part 3).

FIG. 3D is an explanatory drawing showing the method for producing a master disk, according to the embodiment (Part 4).

FIG. 3E is an explanatory drawing showing the method for producing a master disk, according to the embodiment (Part 5).

FIG. 4F is an explanatory drawing showing the method for producing a master disk, according to the embodiment (Part 6).

FIG. 4G is an explanatory drawing showing the method for producing a master disk, according to the embodiment (Part 7).

FIG. 4H is an explanatory drawing showing the method for producing a master disk, according to the embodiment (Part 8).

FIG. 4I is an explanatory drawing showing the method for producing a master disk, according to the embodiment (Part 9).

FIG. 4J is an explanatory drawing showing the method for producing a master disk, according to the embodiment (Part 10).

FIG. 5 is a top view of a master disk.

FIG. 6 is an explanatory drawing showing a cross section of a slave disk.

FIG. 7 is an explanatory drawing showing the magnetization direction of a magnetic layer (recording layer) after an initially magnetizing step.

FIG. 8 is an explanatory drawing showing a magnetic transfer step.

FIG. 9 is a schematic structural drawing of a magnetic transfer apparatus used in a magnetic transfer step.

FIG. 10 is an explanatory drawing showing the magnetization direction of a magnetic layer (recording layer) after the magnetic transfer step.

### DETAILED DESCRIPTION OF THE INVENTION

The following explains a magnetic transfer master carrier according to an embodiment of the present invention.

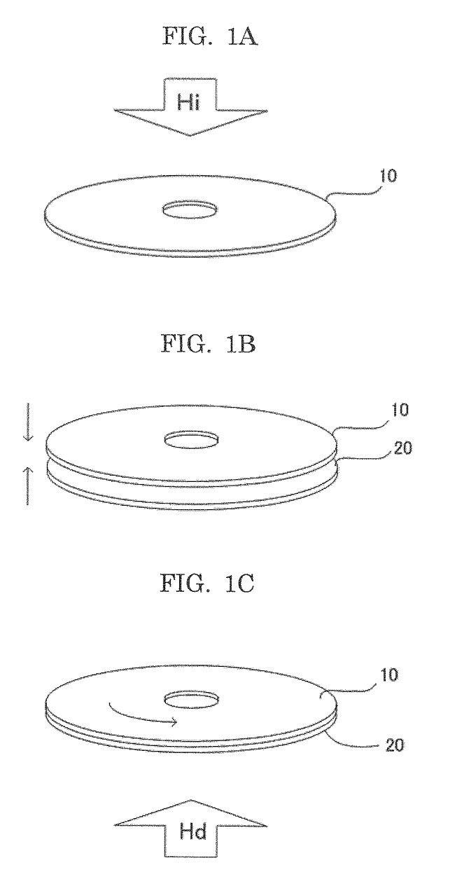

First of all, an outline of a magnetic transfer technique for perpendicular magnetic recording will be explained with reference to FIGS. 1A to 1C. FIGS. 1A to 1C are explanatory drawings showing respective steps in a magnetic transfer method for perpendicular magnetic recording. In FIGS. 1A to 1C, the numeral 10 denotes a slave disk (which is equivalent to a perpendicular magnetic recording medium) as a magnetic disk to which information is to be transferred, and the numeral 20 denotes a master disk as a magnetic transfer master carrier.

As shown in FIG. 1A, an AC magnetic field (Hi) is applied to a surface of the slave disk 10 from a perpendicular direction so as to initially magnetize the slave disk 10 (initially magnetizing step).

After the initially magnetizing step, the initially magnetized slave disk 10 and the master disk 20 are closely attached to each other as shown in FIG. 1B (closely attaching step).

After these disks 10 and 20 have been closely attached to each other, a magnetic field (Hd), which acts in the opposite direction to the direction of the magnetic field (Hi) applied at the time of the initial magnetization, is applied to the disks as shown in FIG. 1C, such that the information which the master disk 20 has is magnetically transferred to the slave disk 10 (magnetic transfer step).

The magnetic transfer master carrier of the present embodiment is equivalent to the master disk 20 shown in FIGS. 1A to 1C. The following explains the master carrier of the present embodiment, referring to this master disk 20 as an example.

### (Master Disk (Master Carrier))

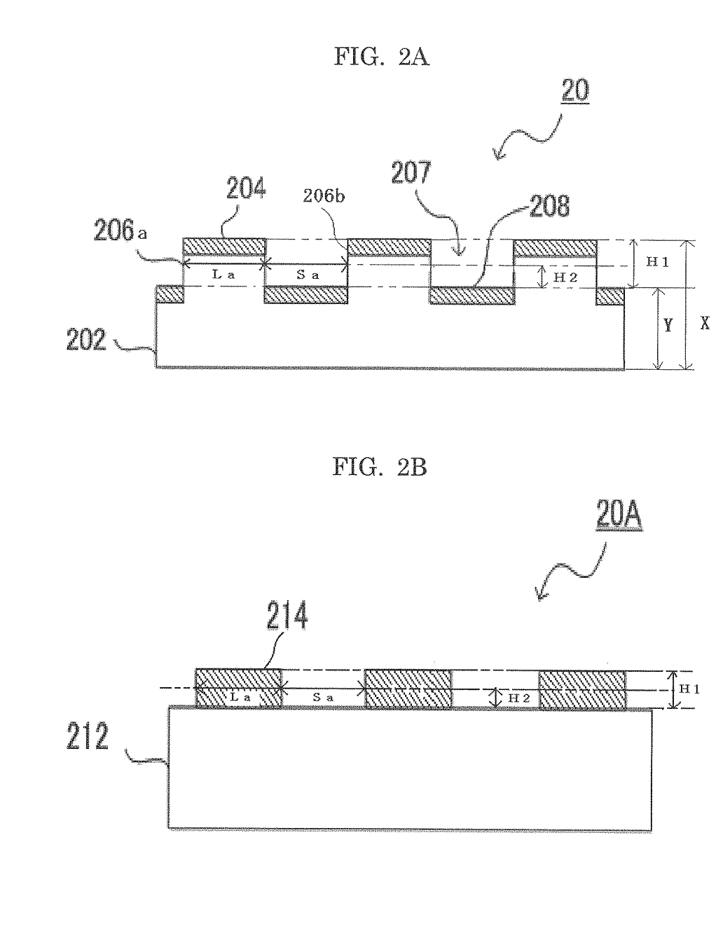

FIG. 2A is a partially cross-sectional view of the master disk (master carrier) 20. This master disk 20 includes a base material 202 and a magnetic layer 204. The base material 202 and the magnetic layer 204 together constitute convex portions 206 and spaces (concave portions) 207. In other words, the convex portions 206 include convex portions of the base material 202 and the magnetic layer 204. In a case where the convex portions 206 are provided with layer(s) such as a protective layer, a lubricant layer and/or an underlying layer described later, the layer(s) are/is also regarded as component(s) of the convex portions 206. Specifically, the height H1 (shown in FIG. 2A) of each convex portion 206 is a value calculated by subtracting the height Y (shown in FIG. 2A) of each space (concave portion) 207 from the sum X (shown in FIG. 2A) of the distance between the bottom surface of the base material 202 and the upper surface of each convex portion of the base material 202 and the thicknesses of the magnetic layer 204 and the layer(s) such as the protective layer, the lubricant layer and/or the underlying layer. In effect, the height H1 of each convex portion 206 is substantially equivalent to the height of each convex portion of the base material 202.

Additionally, in the present embodiment, portions other than the convex portions 206 are also provided with a magnetic layer, which is denoted by the numeral 208, for the sake of facilitation of production, etc. In another embodiment, however, the magnetic layer 204 may be formed on the convex portions 206, without the magnetic layer 208 being formed on portions other than the convex portions 206. It should be noted that the spaces (concave portions) 207 are gaps formed between each convex portion 206.

The magnetic layer 204 formed at the convex portions 206 serves as bit portions corresponding to transfer signal(s). These bit portions are portions where an initial magnetization is reversed, and are equivalent to transfer portions. Meanwhile, the spaces (concave portions) 207 are equivalent to non-transfer portions where a magnetization is not reversed.

In FIG. 2A, a length (La), which is the length of a convex portion 206a with respect to a circumferential direction, and a length (Sa), which is the length of the space 207 between the convex portion 206a and another convex portion 206b (which is adjacent to the convex portion 206a) with respect to the circumferential direction, satisfy the relationship 1.3≦(Sa/La)≦1.9, preferably 1.5≦(Sa/La)≦1.8. Also, a cycle length (La+Sa), which is the sum of the length (La) and the length (Sa), is in the range of 50 nm to 145 nm.

It should be noted that, as shown in FIG. 2A, the length (La) is the width of the convex portion 206a with respect to the circumferential direction measured at a height (H2) equivalent to 50% of the height (H1) of the convex portion 206a, and the length (Sa) is the width of the space (concave portion) 207 with respect to the circumferential direction measured at the height (H2) equivalent to 50% of the height (H1) of the convex portion 206a.

FIG. 2B is a partially cross-sectional view showing a master disk 20A according to another embodiment. This master disk 20A includes a base material 212 and, on a surface of the base material 212, a magnetic layer 214 serving as bit portions corresponding to transfer signal(s). As to this master disk 20A, the magnetic layer 214 is equivalent to the convex portions 206 (transfer portions), and portions (gaps) between adjacent sections of the magnetic layer 214 are equivalent to the spaces (concave portions) 207 (non-transfer portions).

In FIG. 2B, a length (La), which is the length of one section of the magnetic layer 214 (convex portion) with respect to a circumferential direction, and a length (Sa), which is the length of a portion (space) between the one section of the magnetic layer 214 and another section of the magnetic layer 214 (which are adjacent to each other) with respect to the circumferential direction, satisfy the relationship 1.3≦(Sa/La)≦1.9, preferably 1.5≦(Sa/La)≦1.8. Also, a cycle length (La+Sa), which is the sum of the length (La) and the length (Sa), is in the range of 50 nm to 145 nm.

It should be noted that, as shown in FIG. 2B, the length (La) is the width of each section of the magnetic layer 214 (convex portion) with respect to the circumferential direction measured at a height (H2) equivalent to 50% of a height (H1) of the magnetic layer 214 (convex portion), and the length (Sa) is the width of each portion (space) between adjacent sections of the magnetic layer 214 with respect to the circumferential direction measured at the height (H2) equivalent to 50% of the height (H1) of the magnetic layer 214 (convex portion).

### <Base Material>

The base material is produced using a known material, for example glass, a synthetic resin such as polycarbonate, a metal such as nickel or aluminum, silicon or carbon.

### <Magnetic Layer>

The material for the magnetic layer is not particularly limited and may be suitably selected from known materials therefor according to the purpose. Suitable examples thereof include Fe, Co, Ni, FeCo, FeNi, CoNi, CoNiP, FePt, CoPt and NiPt. These may be used individually or in combination.

The thickness of the magnetic layer is not particularly limited and may be suitably selected according to the purpose; generally though, the thickness is in the range of approximately 5 nm to 30 nm.

The method for forming the magnetic layer is not particularly limited, and the magnetic layer may be formed in accordance with a known method, for example sputtering or electrodeposition (electrodeposition method).

A crystal orientation layer for orientation of the magnetic layer and/or a soft magnetic underlying layer may be suitably formed between the base material and the magnetic layer. Note that the soft magnetic underlying layer may have a single-layer structure or a multilayer structure.

A protective layer is formed over the surface of the master disk to improve the mechanical properties, friction resistance and weatherability of the master disk. As the material for this protective layer, a hard carbon film is preferable, and inorganic carbon, diamond-like carbon, etc. formed by sputtering may be used. Further, a layer formed of a lubricant (a lubricant layer) may be formed over this hard protective layer.

A fluorine resin, e.g. perfluoropolyether (PFPE), is generally used as such a lubricant.

### <Method for Producing Master Disk>

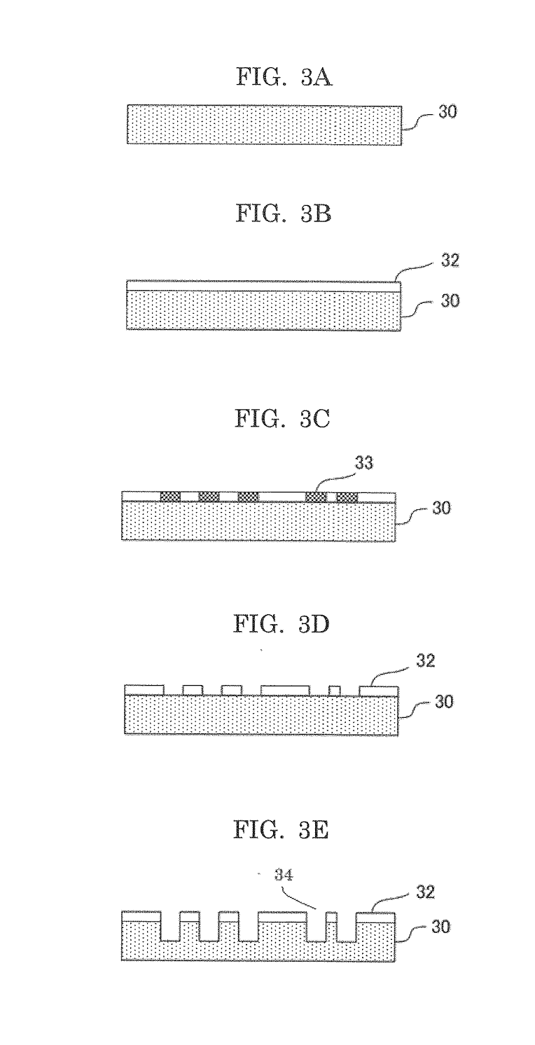

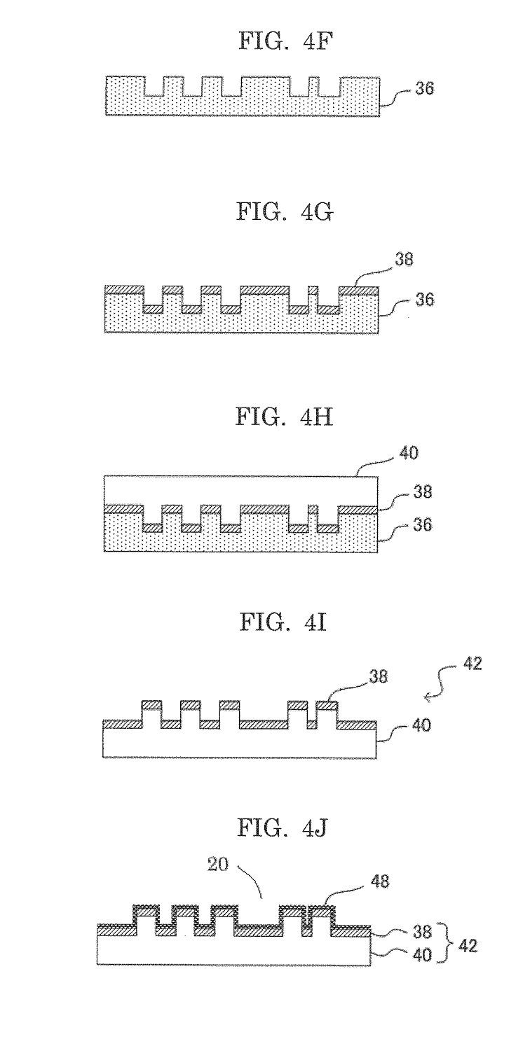

FIGS. 3A to 3E and FIGS. 4F to 4J are explanatory drawings together showing a process of producing a master disk. A method for producing a master disk according to one embodiment will be explained with reference to FIGS. 3A to 3E and FIGS. 4F to 4J.

As shown in FIG. 3A, an original plate (Si substrate) 30, which is a silicon wafer whose surface is smooth, is prepared, an electron beam resist solution is applied onto this original plate 30 by spin coating or the like so as to form a resist layer 32 thereon (see FIG. 3B), and the resist layer 32 is baked (pre-baked).

Next, the original plate 30 is set on a high-precision rotary stage or X-Y stage provided in an electron beam exposure apparatus (not shown), an electron beam modulated correspondingly to a servo signal is applied while the original plate 30 is being rotated, and a predetermined pattern 33 is formed on the substantially entire surface of the resist layer 32; for example, a pattern that corresponds to a servo signal and that linearly extends in radius directions from the rotational center toward each track is formed at portions corresponding to frames on the circumference by writing exposure (electron beam writing) (see FIG. 3C).

Subsequently, as shown in FIG. 3D, the resist layer 32 is developed, the exposed (written) portions are removed, and a coating layer having a desired thickness is formed by the remaining resist layer 32. This coating layer serves as a mask in a subsequent step (etching step). Additionally, the resist applied onto the original plate 30 can be of positive type or negative type; it should be noted that an exposed (written) pattern formed when a positive-type resist is used is an inversion of an exposed (written) pattern formed when a negative-type resist is used. After this developing process, a baking process (post-baking) is carried out to enhance the adhesion between the resist layer 32 and the original plate 30.

Subsequently, as shown in FIG. 3E, parts of the original plate 30 are removed (etched) at places where opening portions 34 of the resist layer 32 exist, such that hollows having a predetermined depth are formed in the original plate 30. As to this etching, anisotropic etching is desirable in that an undercut (side etching) can be minimized. Reactive ion etching (RIE) can be suitably employed as such anisotropic etching.

Thereafter, as shown in FIG. 4F, the resist layer 32 is removed. Regarding the method for removing the resist layer 32, ashing can be employed as a dry method, and a removal method using a release liquid can be employed as a wet method. By the ashing process, an original master 36 on which an inversion of a desired concavo-convex pattern is formed is produced.

Subsequently, as shown in FIG. 4G, a conductive layer 38 is formed on the surface of the original master 36 so as to have a uniform thickness. The method for forming this conductive layer 38 can be suitably selected from metal deposition methods and the like, including PVD (physical vapor deposition), CVD (chemical vapor deposition), sputtering and ion plating. Formation of one layer made of a conductive film (denoted by the numeral 38), as described above, makes it possible to obtain such an effect that a metal can be uniformly electrodeposited in a subsequent step (electroforming step). The conductive layer 38 is preferably a film composed mainly of Ni. Since such a film composed mainly of Ni can be easily formed and is hard, it is suitable as the conductive film. The thickness of the conductive layer 38 is not particularly limited; generally though, the thickness is several tens of nanometers or so.

Then, as shown in FIG. 4H, a metal plate 40 made of a metal (Ni in this case), which has a desired thickness, is laid over the surface of the original master 36 by electroforming (reversed plate forming step). This step is performed by immersing the original master 36 in an electrolytic solution placed in an electroforming device, utilizing the original master 36 as an anode, and passing an electric current between the anode and a cathode. The concentration of the electrolytic solution, the pH, the manner in which the electric current is applied, etc. are required to be adjusted under an optimized condition where the laid metal plate 40 (which is a master substrate equivalent to the base material 202 explained with FIG. 2) does not warp.

The original master 36 over which the metal plate 40 has been laid as described above is taken out from the electrolytic solution in the electroforming device and then immersed in purified water placed in a release bath (not shown).

Subsequently, in the release bath, the metal plate 40 is separated from the original master 36 (separating step), and a master substrate 42 having a concavo-convex pattern which is an inversion of the concavo-convex pattern of the original master 36 is thus obtained as shown in FIG. 4I.

Subsequently, as shown in FIG. 4J, a magnetic layer 48 is formed on the concavo-convex surface of the master substrate 42. Examples of the material for the magnetic layer 48 include FeCo. The thickness of the magnetic layer 48 is preferably 10 nm to 320 nm, more preferably 20 nm to 300 nm, even more preferably 30 nm to 100 nm. The magnetic layer 48 is formed by sputtering, using a target made of the above-mentioned material.

Thereafter, the master substrate 42 is subjected to punching such that its inner and outer diameters have predetermined sizes. By the above-mentioned process, a master disk 20 having the concavo-convex pattern provided with the magnetic layer 48 (equivalent to the magnetic layers 204 and 214 in FIGS. 2A and 2B respectively) is produced as shown in FIG. 4J.

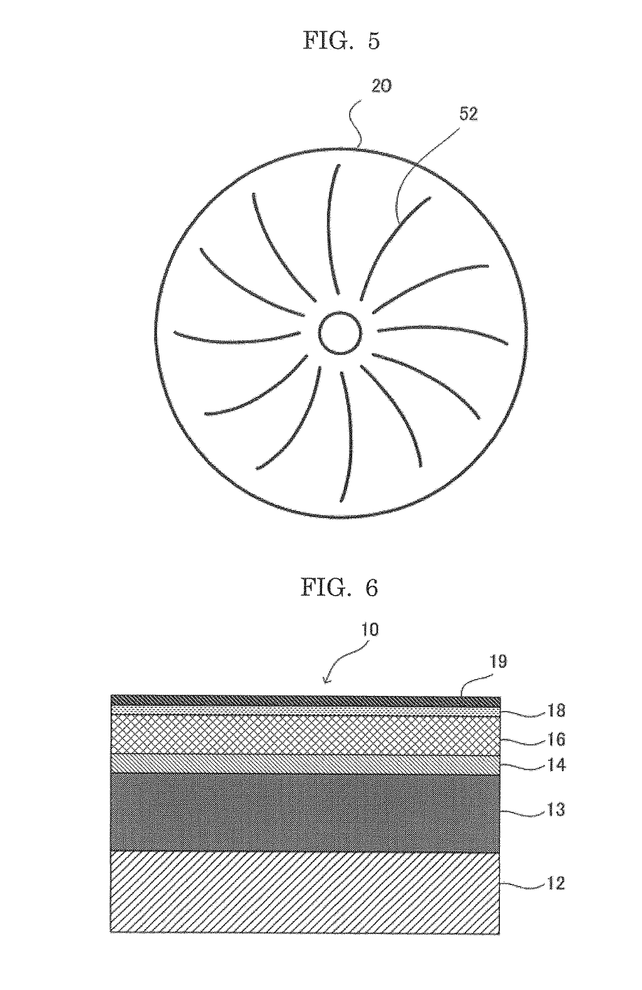

FIG. 5 is a top view of the master disk 20. As shown in FIG. 5, a servo pattern 52 that is a concavo-convex pattern is formed on the surface of the master disk 20. Also, although not shown therein, a protective film (protective layer) made, for example, of diamond-like carbon may be provided over the magnetic layer 48 (see FIG. 4J) on the surface of the master disk 20, and further, a lubricant layer may be provided over the protective film.

The purpose of the provision of the protective layer is to prevent a case in which when the master disk 20 is closely attached to the slave disk 10, the magnetic layer 48 easily gets scratched and the use of the master disk 20 is thus made impossible. The lubricant layer has an effect of preventing, for example, formation of scratches attributed to friction caused when the master disk 20 is brought into contact with the slave disk 10, and thusly improving the durability of the master disk 20.

Specifically, a preferred structure is as follows: a carbon film having a thickness of 2 nm to 30 nm is formed as a protective layer, and a lubricant layer is formed thereon. Also, in order to enhance the adhesion between the magnetic layer 48 and the protective layer, an adhesion enhancing layer of Si or the like may be formed on the magnetic layer 48 before forming the protective layer.

### <Explanation of Slave Disk (Perpendicular Magnetic Recording Medium)>

The slave disk 10 shown in FIGS. 1A to 1C includes a disc-shaped substrate, and magnetic layer(s) formed over one or both surfaces of the substrate. Specific examples thereof include high-density hard disks. The following explains a perpendicular magnetic recording medium with reference to FIG. 6, employing the slave disk 10 as an example.

FIG. 6 is an explanatory drawing showing a cross section of the slave disk 10. As shown in FIG. 6, the slave disk 10 includes a nonmagnetic substrate 12 made, for example, of glass and also includes a soft magnetic layer (soft magnetic underlying layer: SUL) 13, a nonmagnetic layer (intermediate layer) 14 and a magnetic layer (perpendicular magnetic recording layer) 16 formed over the substrate 12. Further, a protective layer 18 and a lubricant layer 19 are formed over the magnetic layer 16. Note that although an example in which the magnetic layer 16 is formed over one surface of the substrate 12 is herein shown, an aspect in which magnetic layers are formed over both surfaces of the substrate 12 is possible as well.

The disc-shaped substrate 12 is made of a nonmagnetic material such as glass or Al (aluminum). After the soft magnetic layer 13 is formed on the substrate 12, the nonmagnetic layer 14 and the magnetic layer 16 are formed.

The soft magnetic layer 13 is useful in that the perpendicularly magnetized state of the magnetic layer 16 can be stabilized and sensitivity at the times of recording and reproduction can be improved. The material used for the soft magnetic layer 13 is preferably selected from soft magnetic materials, for example CoZrNb, FeTaC, FeZrN, FeSi alloys, FeAl alloys, FeNi alloys such as permalloy, and FeCo alloys such as permendur. This soft magnetic layer 13 is provided with magnetic anisotropy in radius directions (in a radial manner) from the center of the disk toward the outside.

The thickness of the soft magnetic layer 13 is preferably 20 nm to 2,000 nm, more preferably 40 nm to 400 nm.

The nonmagnetic layer 14 is provided in order to increase the magnetic anisotropy of the subsequently formed magnetic layer 16 in a perpendicular direction or for some other reason. As the material used for the nonmagnetic layer 14, Ti (titanium), Cr (chromium), CrTi, CoCr, CrTa, CrMo, NiAl, Ru (ruthenium), Pd (palladium), Ta, Pt or the like is preferable. The nonmagnetic layer 14 is formed by depositing the material by means of sputtering. The thickness of the nonmagnetic layer 14 is preferably 10 nm to 150 nm, more preferably 20 nm to 80 nm.

The magnetic layer 16 is formed of a perpendicular magnetization film (which is configured such that magnetization easy axes in a magnetic film are oriented primarily perpendicularly to the substrate), and information is to be recorded in this magnetic layer 16. The material used for the magnetic layer 16 is preferably selected from Co (cobalt), Co alloys (CoPtCr, CoCr, CoPtCrTa, CoPtCrNbTa, CoCrB, CoNi, etc.), Co alloy-SiO₂, Co alloy-TiO₂, Fe, Fe alloys (FeCo, FePt, FeCoNi, etc.) and the like. High in magnetic flux density, any of these materials can have perpendicular magnetic anisotropy by adjustment of a deposition condition and/or its composition. The magnetic layer 16 is formed by depositing the material by means of sputtering. The thickness of the magnetic layer 16 is preferably 10 nm to 500 nm, more preferably 20 nm to 200 nm.

In the present embodiment, a disc-shaped glass substrate having an outer diameter of 65 mm is used as the substrate 12 of the slave disk 10, the glass substrate is set in a chamber of a sputtering apparatus, and the pressure is reduced to 1.33×10⁻⁵ Pa (1.0×10⁻⁷ Torr); thereafter, Ar (argon) gas is introduced into the chamber, and a first SUL having a thickness of 80 nm is deposited by sputtering with the use of a CoZrNb target provided in the chamber, the temperature of the substrate also in the chamber being set at room temperature. Subsequently, a Ru layer having a thickness of 0.8 nm is deposited on the first SUL by sputtering with the use of a Ru target provided in the chamber. Further, a second SUL having a thickness of 80 nm is deposited on the Ru layer by sputtering with the use of a CoZrNb target. With a magnetic field of 50 Oe or higher being applied in radius directions, the temperature of the SULs thus deposited by sputtering is raised to 200° C. and then cooled to room temperature.

Next, sputtering deposition is carried out by means of electric discharge under such a condition that the substrate temperature is made equal to room temperature, with the use of a Ru target. In this manner, the nonmagnetic layer 14 formed of Ru is deposited so as to have a thickness of 60 nm.

Thereafter, in a similar manner, Ar gas is introduced, and sputtering deposition is carried out by means of electric discharge under such a condition that the substrate temperature is made equal to room temperature, with the use of a CoCrPt—SiO₂ target provided in the same chamber. In this manner, the magnetic layer 16 which is formed of CoCrPt—SiO₂ and has a granular structure is deposited so as to have a thickness of 25 nm.

By the above-mentioned process, the transfer magnetic disk (slave disk) 10, in which the soft magnetic layer, the nonmagnetic layer and the magnetic layer have been deposited over the glass substrate, is produced.

### (Magnetic Transfer Method)

A magnetic transfer method of the present invention includes at least an initially magnetizing step, a closely attaching step and a magnetic transfer step and, if necessary, includes other step(s).

### <Initially Magnetizing Step>

The initially magnetizing step is a step of initially magnetizing a perpendicular magnetic recording medium in a perpendicular direction.

Here, note that the perpendicular direction may involve an angular difference of within ±10°, preferably within ±7°, from the vertical direction to the surface of the perpendicular magnetic recording medium.

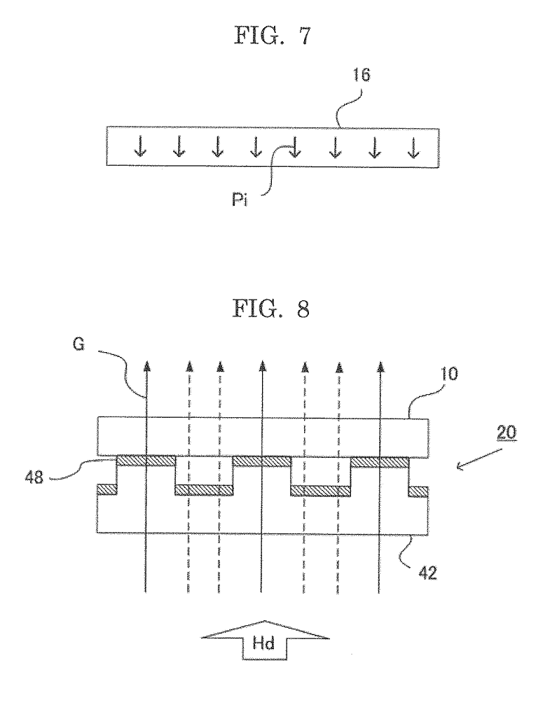

As shown in FIG. 1A, initial magnetization of the slave disk 10 is performed by generation of an initializing magnetic field Hi with the use of a device (magnetic field applying unit (not shown)) capable of applying an AC magnetic field perpendicularly to the surface of the slave disk 10. Specifically, it is performed by generating as the initializing magnetic field Hi a magnetic field which is greater than or equal to the coercive force Hc of the slave disk 10 in strength. By this initially magnetizing step, the magnetic layer 16 of the slave disk 10 is subjected to an initial magnetization Pi in one direction perpendicular to the disk surface, as shown in FIG. 7. It should be noted that this initially magnetizing step may be carried out by rotating the slave disk 10 relatively to the magnetic field applying unit.

The frequency (FI) of the magnetic field applied at the time of the initial magnetization is preferably 0.1 Hz to 5 Hz, more preferably 0.5 Hz to 4 Hz, most preferably 1.0 Hz to 3 Hz.

When the frequency (FI) of the magnetic field applied at the time of the initial magnetization is less than 0.1 Hz, the magnetization may not be sufficiently divided, thereby possibly forming a large domain. When the frequency (FI) is greater than 5 Hz, portions to be initially magnetized may not sufficiently be initially magnetized.

### <Closely Attaching Step>

The closely attaching step is a step of closely attaching a magnetic transfer master carrier to the initially magnetized perpendicular magnetic recording medium. For instance, a step (closely attaching step) is carried out in which, as shown in FIG. 1B, the master disk 20 and the initially magnetized slave disk 10 are laid one on top of the other and closely attached to each other. In the closely attaching step, as shown in FIG. 1B, the surface of the master disk 20 on the side of the protrusion pattern (concavo-convex pattern) and the surface of the slave disk 10 on the side of the magnetic layer 16 are closely attached to each other with a predetermined pressing force.

Before closely attached to the master disk 20, the slave disk 10 is, if necessary, subjected to a cleaning process (burnishing or the like) in which minute protrusions or attached dust on its surface is removed using a glide head, a polisher, etc.

As to the closely attaching step, there is a case in which the master disk 20 is closely attached to only one surface of the slave disk 10 as shown in FIG. 1B, and there is another case in which master disks are closely attached to both surfaces of a transfer magnetic disk, where magnetic layers have been formed. The latter case is advantageous in that transfer to both the surfaces can be simultaneously performed.

### <Magnetic Transfer Step>

The magnetic transfer step is a step of magnetically transferring magnetic information to the perpendicular magnetic recording medium by applying a perpendicular magnetic field which acts in the opposite direction to the direction of the magnetic field applied in the initially magnetizing step, with the perpendicular magnetic recording medium and the magnetic transfer master carrier closely attached to each other.

Note that the opposite direction to the direction of the magnetic field applied in the initially magnetizing step does not necessarily mean the completely opposite direction to the direction of the magnetic field applied in the initially magnetizing step but may involve an angular difference of within ±7° from the completely opposite direction.

Also, the frequency (FP) of the perpendicular magnetic field applied in the magnetic transfer step is preferably 5 Hz to 25 Hz, more preferably 6 Hz to 23 Hz, most preferably 10 Hz to 20 Hz.

When the frequency (FP) of the perpendicular magnetic field applied in the magnetic transfer step is less than 5 Hz, magnetization may be reversed even at the initially magnetized portions. When the frequency (FP) is greater than 25 Hz, magnetization may not be sufficiently reversed at the transfer portions.

Here, the magnetic transfer step is explained with reference to FIG. 1C. To the slave disk 10 and the master disk 20 that have been closely attached to each other by the closely attaching step, a recording magnetic field Hd is generated in the opposite direction to the direction of the initializing magnetic field Hi by a magnetic field applying unit (not shown). Magnetic transfer is effected by entry of a magnetic flux, produced by generating the recording magnetic field Hd, into the slave disk 10 and the master disk 20.

In the present embodiment, the value of the recording magnetic field Hd is approximately equal to that of the coercive force Hc of the magnetic material constituting the magnetic layer 16 of the slave disk 10.

In the magnetic transfer, while the slave disk 10 and the master disk 20 closely attached to each other are being rotated by a rotating unit (not shown), the recording magnetic field Hd is applied by the magnetic field applying unit, and information in the form of the protrusion pattern, recorded on the master disk 20, is magnetically transferred to the magnetic layer 16 of the slave disk 10. Apart from this structure, a mechanism for rotating the magnetic field applying unit may be provided such that the magnetic field applying unit is rotated relatively to the slave disk 10 and the master disk 20.

FIG. 8 shows a cross section of the slave disk 10 and the master disk 20 in the magnetic transfer step. When the recording magnetic field Hd is applied with the slave disk 10 closely attached to the master disk 20 having the concavo-convex pattern as shown in FIG. 8, a magnetic flux G becomes strong in areas where the convex portions of the master disk 20 and the slave disk 10 are in contact with each other, the recording magnetic field Hd causes the magnetization direction of the magnetic layer 48 of the master disk 20 to align with the direction of the recording magnetic field Hd, and thus the magnetic information is transferred to the magnetic layer 16 of the slave disk 10. Meanwhile, at the concave portions of the master disk 20, the magnetic flux G generated by the application of the recording magnetic field Hd is weaker than at the convex portions, and the magnetization direction of portions of the magnetic layer 16 of the slave disk 10 which correspond to the concave portions does not change, so that the portions remain in the initially magnetized state.

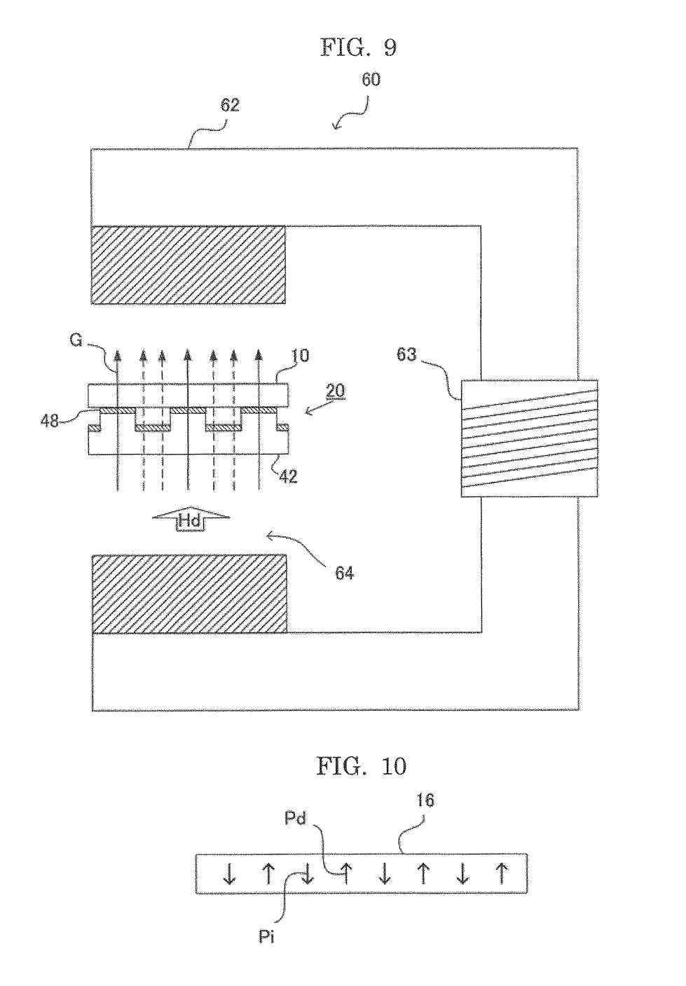

FIG. 9 shows in a detailed manner a magnetic transfer apparatus used for magnetic transfer. The magnetic transfer apparatus includes a magnetic field applying unit 60 composed of an electromagnet which is formed by winding a coil 63 around a core 62. By applying an electric current to the coil 63, a magnetic field is generated in a gap 64 perpendicularly to the master disk 20 and the magnetic layer 16 of the slave disk 10 in a closely attached state. The direction of the magnetic field generated can be changed depending upon the direction of the electric current applied to the coil 63. Therefore, both initial magnetization of the slave disk 10 and magnetic transfer can be performed by this magnetic transfer apparatus.

In the case where magnetic transfer is carried out after initial magnetization is performed, using this magnetic transfer apparatus, an electric current which flows in the opposite direction to the direction of an electric current applied to the coil 63 of the magnetic field applying unit 60 at the time of the initial magnetization is applied to the coil 63. This makes it possible to generate a recording magnetic field in the opposite direction to the magnetization direction at the time of the initial magnetization. In the magnetic transfer, while the slave disk 10 and the master disk 20 closely attached to each other are being rotated, the recording magnetic field Hd is applied by the magnetic field applying unit 60, and the information in the form of the protrusion pattern, recorded on the master disk 20, is magnetically transferred to the magnetic layer 16 of the slave disk 10; accordingly, a rotating unit (not shown) is provided. Apart from this structure, a mechanism for rotating the magnetic field applying unit 60 may be provided such that the magnetic field applying unit 60 is rotated relatively to the slave disk 10 and the master disk 20.

In the present embodiment, magnetic transfer is effected by applying as the recording magnetic field Hd a magnetic field which is equivalent in strength to 60% to 130%, preferably 70% to 120%, of the coercive force Hc of the magnetic layer 16 of the slave disk 10 used in the present embodiment.

Thus, in the magnetic layer 16 of the slave disk 10, information in the form of a magnetic pattern, such as a servo signal, is recorded as a recording magnetization Pd which acts in the opposite direction to the direction of the initial magnetization Pi (see FIG. 10).

### <Other Step(s)>

The other step(s) is/are not particularly limited and may be suitably selected according to the purpose.

### (Magnetic Recording Medium)

A magnetic recording medium of the present invention is a magnetic recording medium on which a servo signal is recorded by the magnetic transfer method of the present invention.

In carrying out the present invention, the protrusion pattern formed on the master disk 20 may be a negative pattern, as opposed to the positive pattern explained with FIG. 4J. In this case, a similar magnetization pattern can be magnetically transferred to the magnetic layer 16 of the slave disk 10 by reversing the direction of the initializing magnetic field Hi and the direction of the recording magnetic field Hd. Also, although a case where the magnetic field applying unit is an electromagnet has been explained in the present embodiment, a permanent magnet which similarly generates a magnetic field may be used as well.

A perpendicular magnetic recording medium produced by the method according to the above-mentioned embodiment of the present invention will be used, installed in a magnetic recording and reproducing device such as a hard disk device, for example. This makes it possible to obtain a high-recording-density magnetic recording and reproducing device with high servo precision and excellent recording and reproducing properties.

### EXAMPLES

The following explains Examples of the present invention. It should, however, be noted that the present invention is not confined to these Examples in any way.

### Example 1

### Production of Master Carrier

An electron beam resist was applied onto an 8 inch Si (silicon) wafer (substrate) by spin coating so as to have a thickness of 100 nm. After the application, the resist on the substrate was exposed using a rotary electron beam exposure apparatus, then the exposed resist was developed, and a resist Si substrate having a concavo-convex pattern was thus produced.

Thereafter, the substrate was subjected to reactive ion etching, with the resist used as a mask, such that concave portions of the concavo-convex pattern enlarged downward. After this etching, the resist remaining on the substrate was removed by washing with a solvent capable of dissolving the resist. After the removal, the substrate was dried, and the dried substrate was used as an original master for producing a master carrier.

The pattern used in Example 1 consisted broadly of a data portion and a servo portion. The data portion was composed of a pattern of 90 nm in convex portion width and 30 nm in concave portion width (TP (track pitch)=120 nm). The servo portion had a reference signal length of 80 nm and a total sector number of 120 and was composed of the following pattern: preamble (40 bits)/SAM (6 bits)/sector code (8 bits)/cylinder code (32 bits)/burst. The SAM portion represented “001010”, binary conversion was employed for the sector code, and gray conversion was employed for the cylinder code. The burst portion was composed of ordinary four bursts (each burst accounted for 16 bits). Manchester encoding was employed for the SAM portion, and an address portion after conversion.

### <Production of Master Carrier Intermediate Member by Plating>

A Ni (nickel) conductive film was formed on the original master by sputtering so as to have a thickness of 20 nm. The original master on which the conductive film had been formed was immersed in a nickel sulfamate bath, and a Ni film having a thickness of 200 μm was formed by electrolytic plating. Thereafter, the Ni film was separated from the original master, which was followed by washing, and a Ni master carrier intermediate member was thus obtained.

### <Method for Forming Magnetic Layer for Magnetic Transfer>

A magnetic layer containing 70 at. % of Fe and 30 at. % of Co was formed on the master carrier intermediate member so as to have a thickness of 100 nm by sputtering under an argon pressure of 0.12 Pa, and a master carrier was thus obtained.

### <Measurement of La and Sa in Concavo-Convex Pattern of Master Carrier Corresponding to Magnetic Information (Servo Information)>

An ultrathin section of the concavo-convex pattern of the master carrier corresponding to magnetic information (servo information) was produced and a high-resolution observation thereof was carried out using a high-performance scanning ion microscope (SMI2050, manufactured by SII NanoTechnology Inc.) and a transmission electron microscope (TEM) (H-9000, manufactured by Hitachi, Ltd.). A length (La), which was the length of a convex portion in the concavo-convex pattern with respect to a circumferential direction, and a length (Sa), which was the length of a space between the convex portion and another convex portion (which was adjacent to the convex portion) with respect to the circumferential direction, were measured.

Here, regarding the preamble, measurement of the length (La) and the length (Sa) was carried out in an area lying between 20 mm and 32 mm in radius, in such a manner that the length (La) and the length (Sa) were measured at intervals of 1 mm and at four places (at angular intervals of 90°) each, and the average values of La and Sa and the ratio (Sa/La) were calculated.

Note that, as shown in FIGS. 2A and 2B, the length (La) was defined as the width of a convex portion measured at a height equivalent to 50% of the height of the convex portion, and the length (Sa) was defined as the width of a space measured at the height equivalent to 50% of the height of the convex portion.

In Example 1, the average value of La was 30 (nm) and the average value of Sa was 50 (nm).

### <Production of Perpendicular Magnetic Recording Medium>

A soft magnetic layer, a first nonmagnetic orientation layer, a second nonmagnetic orientation layer, a magnetic recording layer and a protective layer were formed, in this order, over a 2.5 inch glass substrate by sputtering. Further, a lubricant layer was formed on the protective layer by dipping.

CoZrNb was used as the material for the soft magnetic layer. The soft magnetic layer had a thickness of 100 nm. The glass substrate was placed facing the CoZrNb target, then Ar gas was introduced such that the pressure stood at 0.6 Pa, and the soft magnetic layer was deposited at 1,500 W DC.

A 5 nm layer of Ti was formed as the first nonmagnetic orientation layer, and a 6 nm layer of Ru was formed as the second nonmagnetic orientation layer.

As to the formation of the first nonmagnetic orientation layer, the glass substrate and the soft magnetic layer were placed facing a Ti target, then Ar gas was introduced such that the pressure stood at 0.5 Pa, electric discharge was performed at 1,000 W DC, and a Ti seed layer was deposited so as to have a thickness of 5 nm. After the first nonmagnetic orientation layer had been formed, the glass substrate, the soft magnetic layer and the first nonmagnetic orientation layer were placed facing a Ru target, then Ar gas was introduced such that the pressure stood at 0.8 Pa, electric discharge was performed at 900 W DC, and the second nonmagnetic orientation layer (Ru) was deposited so as to have a thickness of 6 nm.

A 18 nm layer of CoCrPtO was formed as the magnetic recording layer. The glass substrate, the soft magnetic layer, the first nonmagnetic orientation layer and the second nonmagnetic orientation layer were placed facing a CoCrPtO target, then Ar gas containing 0.06% of O₂ was introduced such that the pressure stood at 14 Pa, electric discharge was performed at 290 W DC, and the magnetic recording layer was produced.

After the magnetic recording layer had been formed, the glass substrate, the soft magnetic layer, the first nonmagnetic orientation layer, the second nonmagnetic orientation layer and the magnetic recording layer were placed facing a C (carbon) target, then Ar gas was introduced such that the pressure stood at 0.5 Pa, electric discharge was performed at 1,000 W DC, and a carbon protective layer was formed so as to have a thickness of 4 nm. The coercive force of this recording medium was adjusted to 334 kA/m (4.2 kOe).

Further, a PFPE lubricant was applied over the medium by dipping so as to have a thickness of 2 nm.

As described above, a perpendicular magnetic recording medium was produced.

### <Initially Magnetizing Step>

The perpendicular magnetic recording medium was initially magnetized.

The strength of the magnetic field applied at the time of the initial magnetization (initial magnetic field strength) was 10 kOe. The frequency (FI) of the magnetic field applied at the time of the initial magnetization was 6 Hz.

### <Closely Attaching Step and Magnetic Transfer Step>

The master carrier was placed facing the initially magnetized perpendicular magnetic recording medium, and these were closely attached to each other at a pressure of 1.5 MPa for 30 seconds. With these closely attached to each other, a magnetic field was applied so as to perform magnetic transfer. The strength of the magnetic field used for the magnetic transfer was 4.6 kOe. The frequency (FP) of the magnetic field applied at the time of the magnetic transfer was 27 Hz. After the magnetic field had finished being applied, the master carrier was separated from the perpendicular magnetic recording medium.

### <Evaluation>

### <Servo Signal Qualities>

Servo signal qualities (PRSIGMA and Servo PES) were evaluated as described below. The evaluation results are shown in Table 1.

### <<Measurement of PRSIGMA>>

Waveforms at the preamble portion were detected and collected as data, regarding the perpendicular magnetic recording medium to which the magnetic information had been transferred. An evaluating device (LS-90, manufactured by Kyodo electronics inc.) with a GMR head (120 nm in read width and 200 nm in write width) was used for the detection. The amplitude of the waveform was measured at intervals of 1 mm in an area lying between 20 mm and 32 mm in radius, and the overall average value (PRAM) of the amplitudes of the waveform(s) of signal(s) on the magnetic transfer side and that of the amplitudes of the waveform(s) of signal(s) on the initial magnetization side were calculated, the amplitude uniformity (PRSIGMA=3σ/PRAM(%)) was measured in each radius position, and the servo signal quality was evaluated in accordance with the following evaluation criteria, based upon the PRSIGMA of the preamble portion. Note that the signal(s) on the magnetic transfer side was/were pulse signal(s) at portions where magnetization was reversed at the time of the magnetic transfer, and the signal(s) on the initial magnetization side was/were pulse signal(s) in which reversal of magnetization was reduced at the time of the magnetic transfer, and which remained in the initially magnetized state.

### <<Evaluation Criteria>>

A: The number of sectors in which the PRSIGMA was 20% or higher was less than 5.

B: The number of sectors in which the PRSIGMA was 20% or higher was 5 or more but less than 10.

C: The number of sectors in which the PRSIGMA was 20% or higher was 10 or more.

Note that those evaluated as A or B were usable.

### <<<Servo PES>>>

In addition, a servo PES (position error signal) was evaluated. As an evaluating device, BITFINDER (manufactured by IMES Co., Ltd.) was used. The above-mentioned head in VCM mode was attached to the device, and servo following was evaluated. The PES in a servo following state was measured. The standard deviation (o) was calculated from the measured PES values of sectors with respect to 50 rotations. When the 3σ value was equivalent to less than 15% of the track pitch (TP), the servo PES was judged to be “superior” (A); when the 3σ value was equivalent to 15% or higher but less than 25% of the track pitch (TP), the servo PES was judged to be “acceptable” (B); and when the 3σ value was equivalent to 25% or higher of the track pitch (TP), the servo PES was judged to be “inferior (C)”.

### Examples 2 to 32 and Comparative Examples 1 to 7

In each of Examples 2 to 32 and Comparative Examples 1 to 7, a master carrier and a perpendicular magnetic recording medium were produced in the same manner as in Example 1, except that the values of La and Sa concerning the concavo-convex pattern were changed as shown in Table 1, and that the frequency (FI) of the magnetic field applied at the time of initial magnetization and the frequency (FP) of the magnetic field applied at the time of magnetic transfer were changed as shown in Table 1. The master carriers and the perpendicular magnetic recording media were subjected to the initially magnetizing step, the closely attaching step and the magnetic transfer step, and the evaluations were carried out. The evaluation results are shown in Table 1.

TABLE 1

| | | | | | | | Signal on magnetic | | Signal on initial | | | |
|---|---|---|---|---|---|---|---|---|---|---|---|---|
| | La | Sa | Sa + La | | FP | FI | transfer side | | magnetization side | | | |
| | (nm) | (nm) | (nm) | Sa/La | (Hz) | (Hz) | PRSIGMA | Evaluation | PRSIGMA | Evaluation | PES | Evaluation |
| Ex 1 | 30 | 50 | 80 | 1.7 | 27 | 6 | 6 | B | 9 | B | 23 | B |
| Ex 2 | 30 | 40 | 70 | 1.3 | 27 | 6 | 7 | B | 8 | B | 17 | B |
| Ex 3 | 20 | 30 | 50 | 1.5 | 27 | 6 | 5 | B | 7 | B | 19 | B |
| Ex 4 | 40 | 60 | 100 | 1.5 | 27 | 6 | 5 | B | 6 | B | 20 | B |
| Ex 5 | 40 | 70 | 110 | 1.8 | 27 | 6 | 5 | B | 5 | B | 18 | B |
| Ex 6 | 50 | 65 | 115 | 1.3 | 27 | 6 | 6 | B | 6 | B | 16 | B |
| Ex 7 | 50 | 95 | 145 | 1.9 | 27 | 6 | 5 | B | 7 | B | 15 | B |
| Ex 8 | 30 | 50 | 80 | 1.7 | 27 | 3 | 5 | B | 3 | A | 16 | B |
| Ex 9 | 20 | 30 | 50 | 1.5 | 27 | 3 | 6 | B | 4 | A | 19 | B |
| Ex 10 | 40 | 70 | 110 | 1.8 | 27 | 3 | 5 | B | 5 | B | 17 | B |
| Ex 11 | 30 | 50 | 80 | 1.7 | 27 | 0.1 | 6 | B | 4 | A | 18 | B |
| Ex 12 | 20 | 30 | 50 | 1.5 | 27 | 0.1 | 5 | B | 4 | A | 19 | B |
| Ex 13 | 40 | 70 | 110 | 1.8 | 27 | 0.1 | 5 | B | 5 | B | 20 | B |
| Ex 14 | 30 | 50 | 80 | 1.7 | 27 | 0 | 5 | B | 6 | B | 21 | B |
| Ex 15 | 20 | 30 | 50 | 1.5 | 27 | 0 | 5 | B | 5 | B | 20 | B |
| Ex 16 | 40 | 70 | 110 | 1.8 | 27 | 0 | 5 | B | 7 | B | 23 | B |
| Ex 17 | 30 | 50 | 80 | 1.7 | 4 | 3 | 6 | B | 3 | A | 21 | B |
| Ex 18 | 20 | 30 | 50 | 1.5 | 4 | 3 | 6 | B | 2 | A | 24 | B |
| Ex 19 | 40 | 70 | 110 | 1.8 | 4 | 3 | 6 | B | 3 | A | 19 | B |
| Ex 20 | 30 | 50 | 80 | 1.7 | 7 | 3 | 6 | B | 4 | A | 20 | B |
| Ex 21 | 20 | 30 | 50 | 1.5 | 7 | 3 | 6 | B | 4 | A | 21 | B |
| Ex 22 | 40 | 70 | 110 | 1.8 | 7 | 3 | 5 | B | 4 | A | 22 | B |
| Ex 23 | 30 | 50 | 80 | 1.7 | 25 | 3 | 4 | A | 3 | A | 14 | A |
| Ex 24 | 20 | 30 | 50 | 1.5 | 25 | 3 | 4 | A | 3 | A | 13 | A |
| Ex 25 | 40 | 70 | 110 | 1.8 | 25 | 3 | 4 | A | 4 | A | 15 | B |
| Ex 26 | 30 | 50 | 80 | 1.7 | 40 | 3 | 8 | B | 3 | A | 18 | B |
| Ex 27 | 20 | 30 | 50 | 1.5 | 40 | 3 | 9 | B | 5 | B | 17 | B |
| Ex 28 | 40 | 70 | 110 | 1.8 | 40 | 3 | 7 | B | 4 | A | 19 | B |
| Ex 29 | 30 | 50 | 80 | 1.7 | 20 | 3 | 2 | A | 1 | A | 8 | A |
| Ex 30 | 20 | 30 | 50 | 1.5 | 20 | 3 | 1 | A | 2 | A | 9 | A |
| Ex 31 | 40 | 70 | 110 | 1.8 | 20 | 3 | 2 | A | 0 | A | 7 | A |
| Ex 32 | 40 | 60 | 100 | 1.5 | 20 | 3 | 1 | A | 0 | A | 8 | A |
| Comp | 30 | 30 | 60 | 1.0 | 27 | 6 | 10 | C | 11 | C | 26 | C |
| Ex 1 | | | | | | | | | | | | |
| Comp | 30 | 100 | 130 | 3.3 | 27 | 6 | 11 | C | 10 | C | 28 | C |
| Ex 2 | | | | | | | | | | | | |
| Comp | 20 | 45 | 65 | 2.3 | 27 | 6 | 14 | C | 10 | C | 26 | C |
| Ex 3 | | | | | | | | | | | | |
| Comp | 40 | 45 | 85 | 1.1 | 27 | 6 | 12 | C | 15 | C | 27 | C |
| Ex 4 | | | | | | | | | | | | |
| Comp | 40 | 95 | 135 | 2.4 | 27 | 6 | 13 | C | 15 | C | 28 | C |
| Ex 5 | | | | | | | | | | | | |
| Comp | 50 | 60 | 110 | 1.2 | 27 | 6 | 12 | C | 16 | C | 32 | C |
| Ex 6 | | | | | | | | | | | | |
| Comp | 50 | 100 | 150 | 2.0 | 27 | 6 | 11 | C | 12 | C | 29 | C |
| Ex 7 | | | | | | | | | | | | |

It was confirmed that Examples 1 to 32 were superior to Comparative Examples 1 to 7 (related art) in terms of the evaluation results of both PRSIGMA and servo PES.

Also, it was confirmed that particularly favorable results were obtained regarding Examples 23, 24, and 29 to 32 in which the relationship 1.5(Sa/La) 1.8 was satisfied.

What is claimed is:

1. A magnetic transfer master carrier to be placed on a perpendicular magnetic recording medium, comprising:
a concavo-convex pattern corresponding to magnetic information to be transferred to the perpendicular magnetic recording medium by application of a magnetic field,
wherein a length (La) of a convex portion in the concavo-convex pattern and a length (Sa) of a space between the convex portion and another convex portion adjacent to the convex portion satisfy the relationship 1.3≦(Sa/La)≦1.9, and
wherein a cycle length (La+Sa), which is the sum of the length (La) and the length (Sa), is in the range of 50 nm to 145 nm,
where the length (La) is the width of the convex portion with respect to a circumferential direction measured at a height equivalent to 50% of the height of the convex portion, and the length (Sa) is the width of the space with respect to the circumferential direction measured at the height equivalent to 50% of the height of the convex portion.

2. A magnetic transfer method comprising:
initially magnetizing a perpendicular magnetic recording medium in a perpendicular direction,
closely attaching a magnetic transfer master carrier to the initially magnetized perpendicular magnetic recording medium, and
magnetically transferring magnetic information to the perpendicular magnetic recording medium by applying a perpendicular magnetic field which acts in the opposite direction to the direction of a magnetic field applied in the initially magnetizing, with the perpendicular magnetic recording medium and the magnetic transfer master carrier closely attached to each other,
wherein the magnetic transfer master carrier is a magnetic transfer master carrier placed on the perpendicular magnetic recording medium, which comprises a concavo-convex pattern corresponding to the magnetic information transferred to the perpendicular magnetic recording medium by application of the magnetic field,
wherein a length (La) of a convex portion in the concavo-convex pattern and a length (Sa) of a space between the convex portion and another convex portion adjacent to the convex portion satisfy the relationship 1.3≦(Sa/La)≦1.9, and
wherein a cycle length (La+Sa), which is the sum of the length (La) and the length (Sa), is in the range of 50 nm to 145 nm,
where the length (La) is the width of the convex portion with respect to a circumferential direction measured at a height equivalent to 50% of the height of the convex portion, and the length (Sa) is the width of the space with respect to the circumferential direction measured at the height equivalent to 50% of the height of the convex portion.

3. The magnetic transfer method according to claim 2, wherein a frequency (FI) of the magnetic field applied in the initially magnetizing and a frequency (FP) of the magnetic field applied in the magnetically transferring satisfy the relationship FI≦FP.

4. The magnetic transfer method according to claim 3, wherein the frequency (FP) of the magnetic field applied in the magnetically transferring is in the range of 5 Hz to 25 Hz.

5. The magnetic transfer method according to claim 3, wherein the frequency (FI) of the magnetic field applied in the initially magnetizing is in the range of 0.1 Hz to 5 Hz.

6. A magnetic recording medium, onto which a servo signal has been recorded by a magnetic transfer method comprising:
initially magnetizing a perpendicular magnetic recording medium in a perpendicular direction,
closely attaching a magnetic transfer master carrier to the initially magnetized perpendicular magnetic recording medium, and
magnetically transferring magnetic information to the perpendicular magnetic recording medium by applying a perpendicular magnetic field which acts in the opposite direction to the direction of a magnetic field applied in the initially magnetizing, with the perpendicular magnetic recording medium and the magnetic transfer master carrier closely attached to each other,
wherein the magnetic transfer master carrier is a magnetic transfer master carrier placed on the perpendicular magnetic recording medium, which comprises a concavo-convex pattern corresponding to the magnetic information transferred to the perpendicular magnetic recording medium by application of the magnetic field,
wherein a length (La) of a convex portion in the concavo-convex pattern and a length (Sa) of a space between the convex portion and another convex portion adjacent to the convex portion satisfy the relationship 1.3≦(Sa/La)≦1.9, and
wherein a cycle length (La+Sa), which is the sum of the length (La) and the length (Sa), is in the range of 50 nm to 145 nm,
where the length (La) is the width of the convex portion with respect to a circumferential direction measured at a height equivalent to 50% of the height of the convex portion, and the length (Sa) is the width of the space with respect to the circumferential direction measured at the height equivalent to 50% of the height of the convex portion.
